(19) United States
(12) Patent Application Publication
(10) Pub. No.: US 2016/0240118 A1
(43) Pub. Date: Aug. 18, 2016

(54) 3-D DISPLAY USING LED PIXEL LAYERS

(71) Applicant: Nthdegree Technologies Worldwide Inc., Tempe, AZ (US)

(72) Inventors: Alexander Ray, Tempe, AZ (US); Bradley Oraw, Chandler, AZ (US); Joseph Nathan, Bloomfield Hills, MI (US); Neil Shotton, Tempe, AZ (US); Richard Blanchard, Los Altos, CA (US)

(21) Appl. No.: 15/003,724

(22) Filed: Jan. 21, 2016

Related U.S. Application Data
(60) Provisional application No. 62/197,997, filed on Jul. 28, 2015.
(60) Provisional application No. 62/115,508, filed on Feb. 12, 2015.

(51) Int. Cl. G09G 3/00; G09G 3/32; G02B 27/22

(52) U.S. Cl. CPC G09G 3/003; G02B 27/2278; G09G 3/32; G09G 2300/023; G09G 2300/0452

(57) ABSTRACT

Microscopic LED dice are printed in groups, to form pixels, on a thin transparent substrate, and the LEDs in each pixel are sandwiched between two transparent conductor layers to connect the LEDs in parallel. This forms a single 2-dimensional pixel layer that is substantially transparent, where the pixels are individually addressable. Multiple pixel layers are stacked with an index-matched spacer layer therebetween to form a 3-dimensional array of pixels. If the 3-D display is formed as a cube, the viewing window may be the top pixel layer. All pixel layers are simultaneously viewable through the viewing window since each layer is transparent. Accordingly, 3-dimensional images may be displayed. In another embodiment, one or more LED pixels layers are folded, like an accordion, to achieve a stereoscopic effect so that the left and right eyes see different images to convey depth.

### CROSS-REFERENCE TO RELATED APPLICATIONS

This application claims priority from U.S. provisional application Ser. No. 62/115,508, filed Feb. 12, 2015, and 62/197,997, filed Jul. 28, 2015, assigned to the present assignee and incorporated herein by reference.

### FIELD OF THE INVENTION

This invention relates to light emitting diode (LED) displays and, in particular, to a 3-dimensional LED display using stacked, transparent LED light sheets forming pixel layers.

### BACKGROUND

The present assignee has previously invented a flat light sheet formed by printing microscopic vertical LED dice over a conductor layer on a flexible substrate to electrically contact the LED's bottom electrodes, then printing a thin dielectric layer over the conductor layer which exposes the LED's top electrodes, then printing another conductor layer to contact the LED's top electrodes.

The LEDs may be printed to have a large percentage of the LEDs with the same orientation so the light sheet may be driven with a DC voltage, or the LEDs may be printed so that approximately one-half of the LEDs have one orientation and the other half has the opposite orientation so an AC signal can drive all the LEDs. In either case, a large number of the LED dice are connected in parallel.

By using a transparent film as the substrate and making either or both of the conductor layers transparent, light may exit through either surface or both surfaces simultaneously. If the LEDs are GaN-based and emit blue light, a phosphor layer may be deposited over the LEDs to cause the emission to be any color. The light sheets may be formed to have a thickness less than 100 microns. Since the printed LEDs are microscopic and dispersed, and the conductors and substrate are transparent, the resulting light sheets are substantially transparent.

Further detail of forming a light source by printing microscopic vertical LEDs, and controlling their orientation on a substrate, can be found in US application publication US 2012/0164796, titled, Method of Manufacturing a Printable Composition of Liquid or Gel Suspension of Diodes, assigned to the present assignee and incorporated herein by reference.

The assignee's light sheet is ideally suited for providing general illumination or backlighting. However, it is also desirable to adapt the assignee's light sheet technology to create addressable or static displays, including a display that can display 3-dimensional images.

### SUMMARY

A 3-D display is formed of stacked, transparent LED pixel layers with index-matched spacer layers between the pixel layers. The structure may form a cube or other shape. The LEDs are printed in addressable pixel locations on each 2-D pixel layer. Opaque cells may optically separate each pixel area to reduce lateral diffusion of light. Each pixel may have a diameter of, for example, 10-40 microns.

By controlling the brightness of each pixel area in each of the pixel layers, a 3-D image may be generated. In one embodiment, the viewing window of the display is above the top light sheet, and the side walls of the structure are light absorbing. Image processing may be used to dynamically rotate the displayed image to allow viewing the image from all angles.

The 3-D display may be used for a variety of purposes including as a tool to better understand actual or simulated structures. Any other 3-D scene or image may also be displayed. Line images generated by CAD systems are especially suitable for display.

The 3-D display may be monochrome or full color.

### BRIEF DESCRIPTION OF THE DRAWINGS

FIG. 1 is a cross-section of a very small portion of a thin, transparent pixel layer showing one addressable pixel area, where light is only emitted in one direction.

FIG. 2 is similar to FIG. 1 except the pixel layer is configured to emit light bi-directionally.

FIG. 3 is a top down view of four addressable pixels on the pixel layer of FIG. 1 or 2.

FIG. 4 illustrates how a single pixel may be composed of red, blue, and green subpixels, either formed using RGB LEDs or using phosphors.

FIG. 5 is a cross-section of a pixel area formed using three laminated pixel layers, where each layer is formed using a different primary color LED.

FIG. 6 is a top down view of a 6×6 array of addressable pixels in a single pixel layer. Each pixel may be surrounded by an opaque wall to prevent lateral dispersion of light (cross-pixel noise). Only LEDs in two pixels are shown.

FIG. 7 is a perspective view of stacked, transparent pixel layers, forming a 3-D display, where the pixels in each layer are individually addressable using XY drive signals to control brightness levels.

FIG. 8 is a cross-section of a portion of a 3-D display, where each pixel is formed by RGB LEDs in a set of overlapping pixel layers, where adjacent sets are spaced by an index-matched spacer layer.

FIG. 9 is a top down view of a small portion of the top pixel layer in a 3-D display, showing pixels being addressed and emitting different brightness levels.

FIG. 10 illustrates a 3-D image of a cube being viewed through the viewing window of the 3-D display. Any angle of the image may be displayed using appropriate processing.

FIG. 11 illustrates a scene being viewed through the viewing window of the 3-D display.

FIG. 12 illustrates how processing of the 3-D displayed image can cause the visual impression of convergence to a point toward the rear of the 3-D display to give the effect of greater depth.

FIG. 13 illustrates how processing of the 3-D displayed image can cause the visual impression of divergence from a central point to give the impression of closeness.

FIG. 14 is a perspective view of a 3-D display having three pixel layers, where areas of a pixel layer intended to be completely obscured by a more foreground image are not energized.

FIG. 15A illustrates a 3-D display image of squares when viewed normal to the display surface, where each of three pixel layers displays an array of squares offset from the other pixel layers.

FIG. 15B illustrates a 3-D display image of the squares of FIG. 15A when viewed at a first angle to the display surface, where the squares overlap somewhat.

FIG. 15C illustrates a 3-D display image of the squares of FIG. 15A when viewed at a second angle to the display surface, where the squares overlap somewhat.

FIG. 16 illustrates a single pixel layer, or laminated pixel layers, folded like an accordion to achieve a stereoscopic 3-D effect.

FIG. 17 illustrates a single pixel layer, or laminated pixel layers, molded to have indented pyramidal cells with angled segments to achieve a 3-D effect.

FIG. 18 illustrates a stepped (or cascaded) pixel layer for achieving a stereoscopic 3-D effect from different angled segments seen from the left and right eyes and for also providing a physical depth of the display to enhance the 3-D effect.

FIG. 19 illustrates multiple overlapping cascaded pixel layers for further enhancing the 3-D effect.

Elements that are similar or identical in the various figures are labeled with the same numeral.

### DETAILED DESCRIPTION

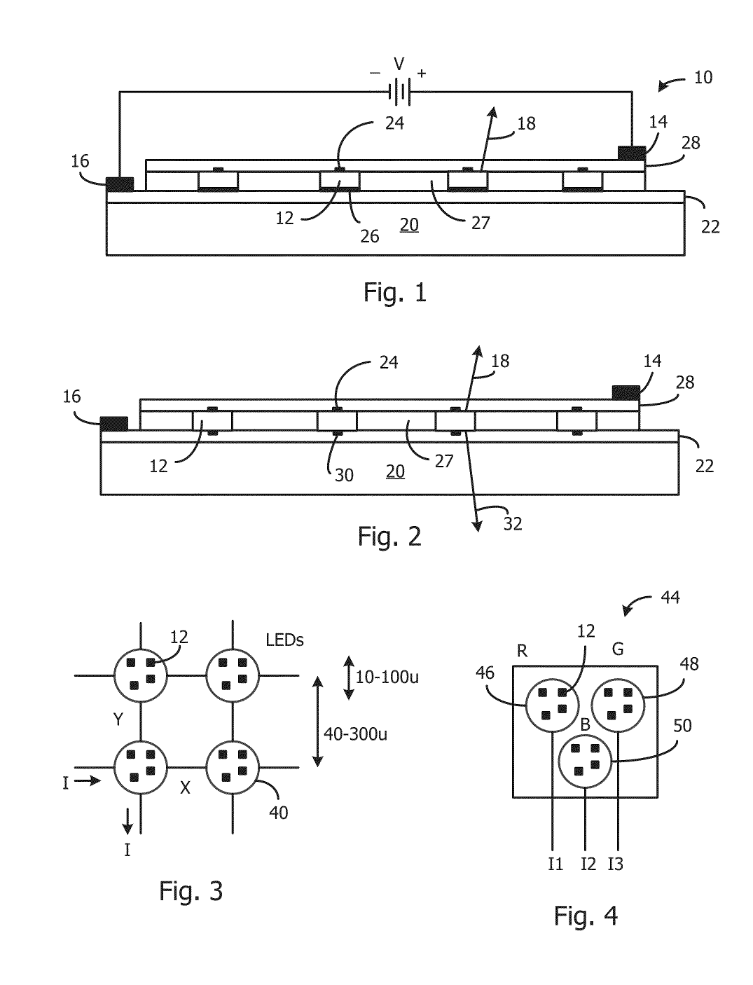

FIG. 1 is a cross-section of a single pixel in a transparent pixel layer 10. The layer 10 may have a thickness between 1-10 mils (about 25-250 microns). The LEDs 12 in the pixel are energized by a suitable driving voltage applied to the electrodes 14 and 16. A light ray 18 emitted from one of the LEDs 12 is shown.

In FIG. 1, a transparent starting substrate 20 may be polycarbonate, PET (polyester), PMMA, Mylar or other type of polymer sheet. The substrate 20 may be later removed to reduce light absorption. In one embodiment, the substrate 20 is about 25 microns thick.

A transparent conductor layer 22 is then deposited over the substrate 20, such as by printing. A suitable transparent conductor layer 22 may be ITO or a sintered silver nano-wire layer.

A monolayer of microscopic inorganic LEDs 12 is then printed over the conductor layer 22. The LEDs 12 are vertical LEDs and include standard semiconductor GaN layers, including an n-layer, and active layer, and a p-layer. GaN LEDs typically emit blue light. The LEDs 12, however, may be any type of LED emitting red, green, yellow, or other color light. The LEDs 12 are printed in a matrix of pixel locations. Such selective printing may be by screen printing (using a mask pattern), flexography, or other type of printing.

If each pixel is to be surrounded by an opaque wall, such walls (cells) may be printed prior to the LEDs 12. The walls may instead be provided by a laminated layer or using other methods such as trenching and filling in the trenches with an opaque material. The cells may be square, hexagonal, circular, or any other shape.

The GaN-based micro-LEDs used in embodiments of the present invention are less than a third the diameter of a human hair and less than a tenth as high, rendering them essentially invisible to the naked eye when the LEDs are sparsely spread across the substrate 20. This attribute permits construction of a nearly or partially transparent light-generating layer made with micro-LEDs. In one embodiment, the LEDs 12 have a diameter less than 25 microns and a height less than 10 microns. The number of micro-LED devices per unit area may be freely adjusted when applying the micro-LEDs to the substrate 20. Further detail of forming a light source by printing microscopic vertical LEDs, and controlling their orientation on a substrate, can be found in US application publication US 2012/0164796, entitled, Method of Manufacturing a Printable Composition of Liquid or Gel Suspension of Diodes, assigned to the present assignee and incorporated herein by reference.

In one embodiment, an LED wafer, containing many thousands of vertical LEDs, is fabricated so that the top metal electrode 24 for each LED 12 is small to allow light to exit the top surface of the LEDs. The bottom metal electrode 26 is reflective (a mirror) and should have a reflectivity of over 90% for visible light. There is some side light, depending on the thickness of the LED. In the example, the anode electrode is on top and the cathode electrode is on the bottom. In other embodiments, the top electrode may cover the entire surface of the LED and is reflective, and light exits the bottom of the LED through the transparent conductor layer 22 and the transparent substrate 20. In another embodiment, the electrodes are formed so that light is emitted bi-directionally.

The LEDs are completely formed on the wafer, including the anode and cathode metallizations, by using one or more carrier wafers during the processing and removing the growth substrate to gain access to both LED surfaces for metallization. The LED wafer is bonded to the carrier wafer using a dissolvable bonding adhesive. After the LEDs are formed on the wafer, trenches are photolithographically defined and etched in the front surface of the wafer around each LED, to a depth equal to the bottom electrode, so that each LED has a diameter of less than 25 microns and a thickness of about 4-8 microns, making them essentially invisible to the naked eye. A preferred shape of each LED is hexagonal. The trench etch exposes the underlying wafer bonding adhesive. The bonding adhesive is then dissolved in a solution to release the LEDs from the carrier wafer. Singulation may instead be performed by thinning the back surface of the wafer until the LEDs are singulated. The LEDs 12 of FIG. 1 result, depending on the metallization designs. The microscopic LEDs 12 are then uniformly infused in a solvent, including a viscosity-modifying polymer resin, to form an LED ink for printing, such as screen printing, or flexographic printing.

The LEDs 12 may instead be formed using many other techniques and may be much larger or smaller. The lamps described herein may be constructed by techniques other than printing.

The LED ink is then printed over the conductor layer 22. The orientation of the LEDs 12 can be controlled by providing a relatively tall top electrode 24 (e.g., the anode electrode), so that the top electrode 24 orients upward by taking the fluid path of least resistance through the solvent after printing. The anode and cathode surfaces may be opposite to those shown. The LED ink is heated (cured) to evaporate the solvent. After curing, the LEDs 12 remain attached to the underlying conductor layer 22 with a small amount of residual resin that was dissolved in the LED ink as a viscosity modifier. The adhesive properties of the resin and the decrease in volume of resin underneath the LEDs 12 during curing press the bottom cathode electrode 26 against the underlying conductor layer 22, creating a good electrical connection. Over 90% like orientation has been achieved, although satisfactory performance may be achieved with over 75% of the LEDs being in the same orientation.

A dielectric layer 27 is then selectively printed over the conductor layer 22 to encapsulate the sides of the LEDs 12 and further secure them in position. The ink used in the dielectric layer 27 pulls back from the upper surface of the LEDs 12, or de-wets from the top of the LEDs 12, during curing to expose the top electrodes 24. If any dielectric remains over the LEDs 12, a blanket etch step may be performed to expose the top electrodes 24.

Another transparent conductor layer 28 is then printed to contact the top electrodes 24. The conductor layer 28 may be ITO or may include silver nano-wires. The conductor layer 28 is cured, for example, by lamps to create good electrical contact to the electrodes 24.

The LEDs 12 in the monolayer, within a defined pixel area, are connected in parallel by the conductor layers 22/28 since the LEDs 12 have the same orientation. Since the LEDs 12 are connected in parallel, the driving voltage must approximately equal the voltage drop of a single LED 12.

Many other ways can be used to form the LEDs 12, and the LEDs 12 do not need to be microscopic or printed for the present invention to apply.

A flexible, protective layer (not shown) may be printed over the transparent conductor layer 28. If wavelength conversion is desired, a phosphor layer may be printed over selected pixel areas.

The pixel layer 10 may be any size and have any number of pixels, where the electrodes 14 and 16 form row and column conductors to address the pixel at the intersection of an energized row and column.

The pixel layer 10 may even be a continuous sheet formed during a roll-to-roll process that is later stamped out.

FIG. 2 is identical to FIG. 1 except the bottom LED electrode 30 is small to allow light to be emitted from both the top and bottom of each LED 12. Emitted light rays 18 and 32 are shown.

Although the pixel layers are described as transparent, they are actually semi-transparent or substantially transparent due to some inherent light absorption of the various layers and the LEDs. Therefore, there is a practical limit to the number of pixel layers that can be stacked. The light absorption may be compensated for by operating the rear pixels to be progressively slightly brighter such that a target brightness is achieved at the front viewing window of the 3-D display.

FIG. 3 is a top down view illustrating a small portion of the pixel layer of FIG. 1 or 2, showing four pixels 40. Many more pixels are included in a single pixel layer. Each pixel 40 has at least one LED 12 within it, and most likely has between 2-5 LEDs within it. For a monochromatic display, no phosphor is needed. If a color display is desired, and all the LEDs 12 are GaN types emitting blue light, some pixels may be covered with a red phosphor and other pixels covered with a green phosphor to create controllable RGB pixels to produce a wide gamut of colors. The LEDs 12 in each pixel 40 are sandwiched between two transparent conductor layers, as described with respect to FIG. 1. All LEDs in a column are printed over a column conductor strip (Y lines), and all LEDs in a row have their top electrodes contacted by a transparent row conductor strip (X lines). By selectively applying the anode voltage (e.g., 3-4 volts) and cathode voltage (e.g., ground) to the Y and X conductors, only the pixel at the intersection of energized conductors will be illuminated. The bottom left pixel is shown energized by the current I flowing through it. At high scanning speeds, animation may be displayed. The pixels 40 may have any pitch that is achievable using printing. Pitches less than 500 microns are achievable.

If the current supplied to multiple pixels is the same, each energized pixel provides the same brightness whether the pixel contains one LED or five LEDs. Therefore, such current-controlled driving of pixels is ideally suited for a non-deterministic LED printing process.

FIG. 4 illustrates how a single pixel 44 on a pixel layer can be formed of a red sub-pixel 46, a green sub-pixel 48, and a blue-sub-pixel 50, where the relative currents (IL 12, 13) to each sub-pixel define the overall color for that pixel. The LEDs 12 may be red, green, and blue LEDs. Alternatively, all the LEDs may be blue LEDs, and the red-sub-pixel 46 has a red phosphor printed over it, and the green-sub-pixel 48 has a green phosphor printed over it.

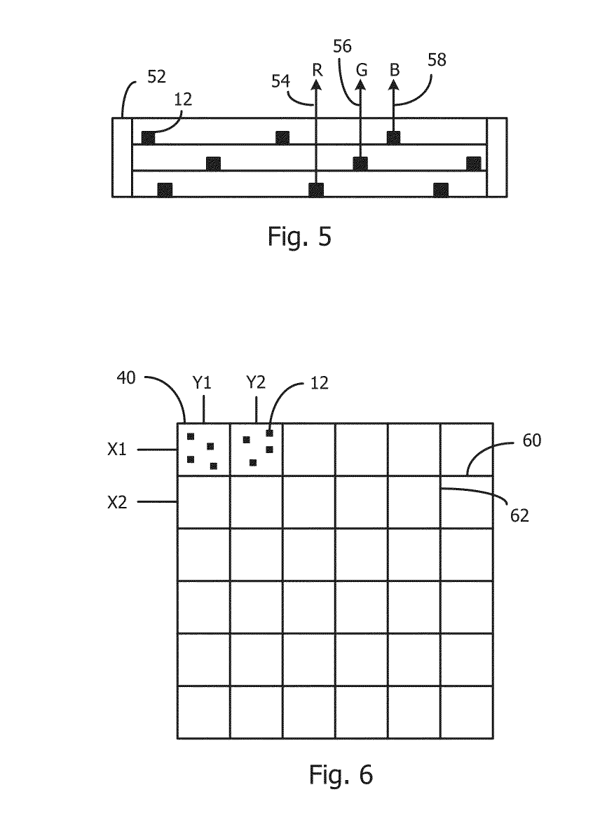

The red, green, and blue sub-pixels may be laterally displaced, as shown in FIG. 3 or 4, or the red, green, and blue sub-pixels may be vertically displaced as shown in FIG. 5. In FIG. 5, three overlapping pixel layers are shown. Each layer outputs either red light, green light, or blue light using appropriate type printed microscopic LEDs 12. The pixel layers are either laminated together, or the red, green, and blue LEDs may be successively printed, with a transparent conductor layer therebetween. An opaque wall 52 surrounds each pixel area to prevent lateral light from creating noise in other pixels. The LEDs in each of the three layers are independently energized with a current to create the desired mixture of colors for the pixel. Any X-Y addressing technique may be used to energize a selected color LED in each pixel. The RGB light (rays 54, 56, and 58) blends very well and there will be statistically little or no overlap of LEDs due to the microscopic size of each LED and the random distribution of LEDs. Any statistically calculated overlap of LEDs, creating some light blockage, may be compensated for by adjusting the density of LEDs in each layer.

FIG. 6 is a top down view of a single pixel layer having a 6×6 matrix of pixels. Each pixel 40 is addressable using X and Y signals, and each pixel 40 may include RGB subpixels. The grid may represent thin metal (or transparent conductor) row conductors 60 and thin metal (or transparent conductor) column conductors 62 that are connected to the transparent conductor layers 22/28 (FIG. 1) for each pixel 40. The metal may even be used to form opaque walls around each pixel 40.

In one embodiment, the bottom transparent conductor layer for the LEDs is a continuous layer. A dielectric pattern is then printed over the conductor layer, such as with black ink, so that any LEDs printed on the dielectric pattern do not conduct. This dielectric pattern may be the grid shown in FIG. 6 that defines the pixels. In this way, all the LEDs that can be energized are confined to the pixel areas. The black ink may be thick to provide opaque walls between pixels to prevent lateral cross-talk between the pixels.

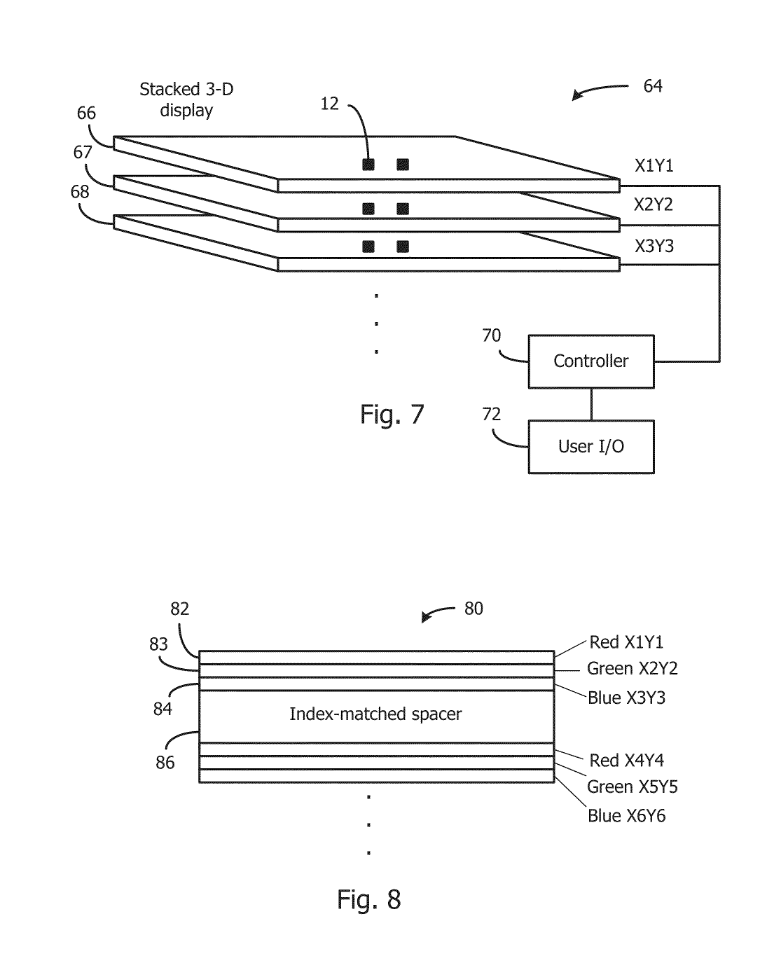

FIG. 7 illustrates a 3-D display 64 formed using overlapping, transparent pixel layers 66-68, where LEDs 12 are illuminated along the X, Y, and Z directions like pixels. Although only two LEDs 12 per pixel layer are shown for simplicity, there may be thousands of addressable LED pixels in each pixel layer. An ordered array of individually addressable groups of LEDs (e.g., 2-3 LEDs per group) may be printed, where each group is a pixel. X and Y conductors may be connected to each group so that any pixel on a pixel layer can be individually addressed by providing the proper voltage across addressed X and Y conductors to illuminate the pixel at the intersection of the energized XY conductors. The brightness of any addressed pixel is controllable by controlling the current. The proper current level may be determined by a look-up table that cross-references a digital code with the current level. Controlling current levels using binary values is well known.

The XY conductors may be formed by a transparent conductor. The pixels may be monochromatic, or RGB, or other colors.

Each pixel layer 66-68 may be about 1 mil thick, so transparent spacer layers may be needed between the pixel layers 66-68 to cause the XY pixel pitch to be about the same as the Z pixel pitch. The spacer material should have the same index of refraction as the pixel layers 66-68 to minimize internal reflection.

A controller 70 supplies different X and Y address signals to each pixel layer 66-68 in the stack to create a desired 3-D arrangement of illuminated pixels. The current for each pixel is precisely controlled to correspond to the target brightness of each pixel. A digital code corresponding to a brightness level of a particular pixel may be provided to the controller 70, which then supplies the target current to the appropriate pixel. The pixels in the transparent pixel layers 66-68 may emit light in a single direction or bidirectionally. The 3-D display 64 may be formed as a cube, with a viewing window over the top pixel layer 66.

In one embodiment, the cube is about 4-6 inches per side, and non-portable displays may be made much larger. All sides except the viewing window may be covered with an opaque layer to prevent internal reflection.

The 3-D image may be programmed by a user I/O interface 72. In one embodiment, the 3-D image is an object that has been created using a CAD application, and the 3-D image produced enables the user to better grasp the 3-D design. The 3-D image may also be from a 3-D camera or any other source. The 3-D image may be static or be animated. In one simple embodiment, each pixel layer 66-68 has about 10,000 addressable pixels (100×100), and there are 100 stacked pixel layers so there are 100 pixels in each of the X, Y, and Z directions. Any other size and resolution can be made using a printing process.

In another embodiment, the controller 70 simply energizes a fixed group of the pixels for a permanent static display. In such an embodiment, the controller 70 may be a simple programmed interconnection of the pixels to a power source, where the connections to the power source are permanent.

FIG. 8 illustrates a full color 3-D display 80, which may be formed as a cube. Each horizontal level of full-color pixels is formed by red, green, and blue pixels provided in separate and abutting pixel layers 82, 83, and 84, respectively. The red, green, and blue LEDs associated with a particular pixel location may be simultaneously energized by application of an appropriate current at the XY intersection of the pixel for each of the pixel layers. Each pixel layer is transparent. An index-matched spacer sheet 86 is shown, which may be the same material as the light sheet substrate (e.g., PET, PMMA, etc.). The 3-D image is viewable through the top and bottom surfaces of the cube, and the side surfaces may be coated with a light absorbing material.

In one embodiment, the pixels in different pixel layers are slightly offset from each other in the X and Y directions to minimize the blockage of light and to reduce cross-talk between different pixel layers in the Z-direction.

In another embodiment, concentric spheres of the light sheets may form pixel layers in a spherical 3-D display. In such a case, the 3-D image may be viewable from any angle. Concentric shells of the LED layers and other layers may printed or sprayed over a starting sphere substrate. All conductors may be terminated at one area of the sphere for the XYZ signals. Cylindrical 3-D displays are also practical, using circular pixel layers.

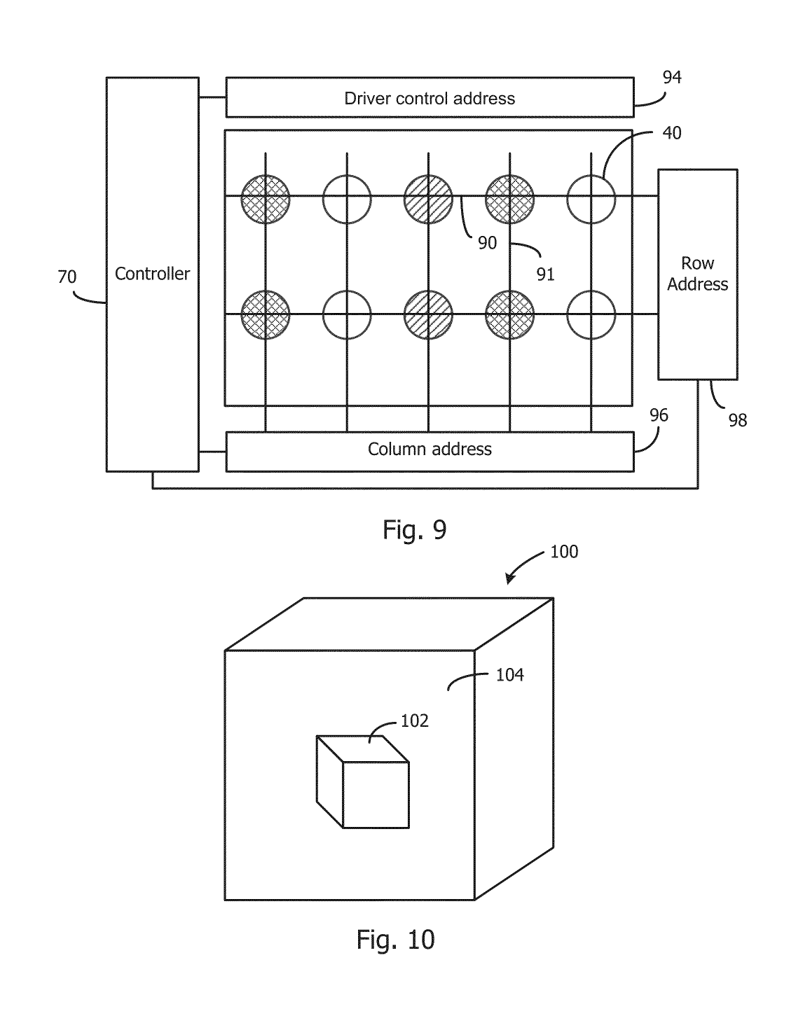

FIG. 9 is another representation of the 3-D display where the top pixel layer forms a 2×5 array of pixels 40. Row and column conductors 90 and 91 are shown. A driver control address block 94 supplies a digital code to the controller 70 that identifies the brightness of selected pixels 40. The controller 70 then selects the appropriate current for the target pixel, and the column address block 96 and row address block 98 supply the current to the selected pixel 40. The pixels 40 receive the energizing current for a single frame time, and the display is then updated. Animation or still images may be displayed. A processor may supply the digital addresses and brightness levels in accordance with any suitable imaging/rendering routine. In one embodiment, effects, such as shading, may be applied via the processor. In the example of FIG. 9, the different brightness levels of the pixels 40 are represented by the different shadings.

FIG. 10 illustrates a 3-D display cube 100 displaying a simple cube image 102 through the viewing window 104, where the cube image 102 may be suitably shaded and rotated using a programmed processor.

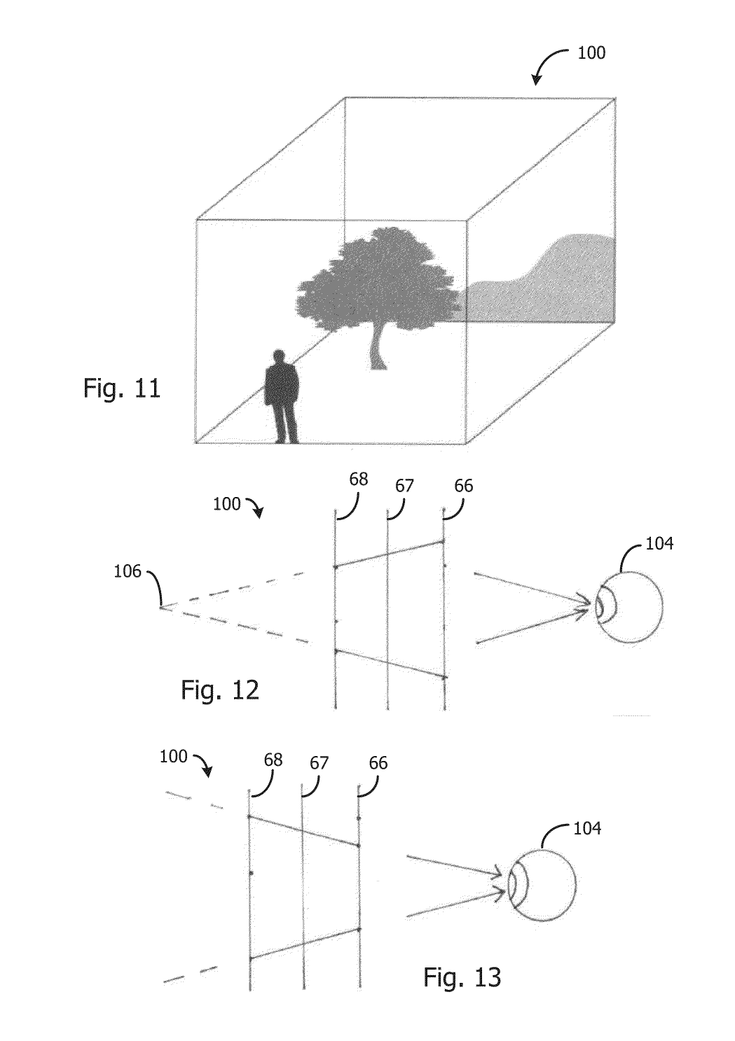

FIG. 11 illustrates another 3-D image displayed by the cube 100 where different 2-D images are displayed on different pixel layers to create an overall scene. In the example, the 2-D images are a man, a tree, and a hill. The relative positions of the images change as the cube 100 is angled with respect to the viewer. Much more complex images are envisioned. The cube 100 pixels may be monochrome or full color. To reduce pixel cross-talk in the Z direction, the pixels directly behind a foreground image may be “driven” off (similar to masking). This technique also achieves the effect of the man in the foreground blocking the light from the images in the background.

In another example, a topological map is displayed, and the different views are achieved by tilting the cube and/or controlling a processor to tilt the image.

Monochromatic line images are particularly suitable for display, such as for CAD outlines of objects to be fabricated, or molecular structures for education, etc. The images generated may be dynamic, requiring dynamic addressing, or the images may be static, requiring no addressing after the initial programming of the pixels.

FIG. 12 is a cross-section of a 3-D display cube 100 showing pixel layers 66, 67, and 68, and a viewer 104 looking into the cube 100. FIG. 12 illustrates how processing of the 3-D displayed image can cause the visual impression of convergence to a point 106 toward the rear of the cube 100 to give the effect of greater depth.

FIG. 13 depicts the same cube 100 and illustrates how processing of the 3-D displayed image can cause the visual impression of divergence from a central point to give the impression of closeness.

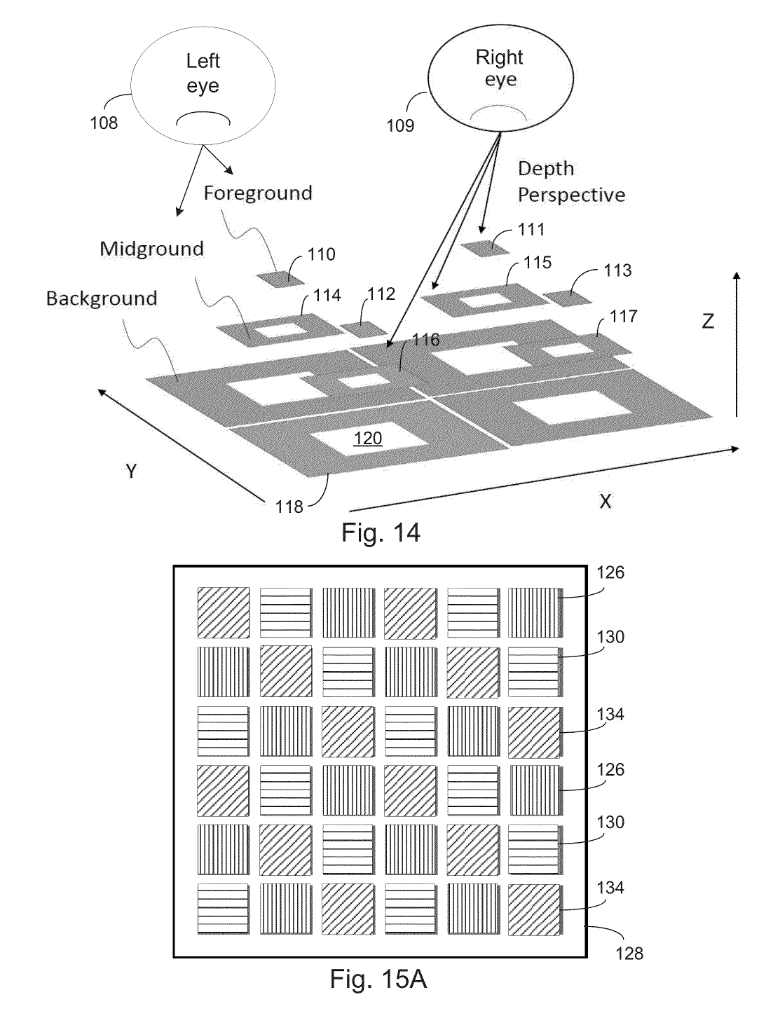

FIG. 14 illustrates the achievement of a 3-D effect, similar to the technique of FIG. 11, by stacking 2-D images in the Z direction, with a transparent spacer in-between. In the simplified example of FIG. 14, only three pixel layers are used for foreground, midground, and background, although any number of layers can be used to achieve the desired depth resolution. The displayed images in FIG. 14 are just depicted as opaque rectangles for simplicity. The viewer's left and right eyes 108 and 109 are depicted.

In the example, the foreground pixel layer (the top pixel layer) has LED pixels energized to display four rectangles 110-113. The remaining pixels in the foreground pixel layer are off, so the underlying pixel layers are visible through the transparent substrate.

The midground pixel layer (the middle pixel layer) has LED pixels energized to display four rectangles 114-117, where rectangles 114-117 have a central “obscured” zone corresponding to the area that would be covered by the rectangles 110-113 if a viewer viewed the display normal to the display surface. Since the LEDs are off in those obscured areas, the midground pixel layer does not distort the images in the foreground pixel layer. The remaining pixels in the midground pixel layer are off, so the underlying pixel layers are visible through the transparent substrate. Many more midground pixel layers for different depths can be employed.

Similarly, the background pixel layer (the bottom pixel layer) has LED pixels energized to produce the displayed pattern 118 of four background rectangles, where obscured zones 120 (LEDs are off) correspond to the areas that would be covered by the images in the foreground and midground pixel layers if a viewer viewed the display normal to the display surface.

Accordingly, the display provides physical depth for an image. The image itself may be processed to convey more depth.

In all embodiments, the display may be hand held. Accelerometers (or other suitable sensors) in the display, and/or a camera in the display, may convey the orientation of a viewer's eyes relative to the display screen and adjust the displayed images accordingly to achieve a realistic 3-D effect. In the case of FIG. 14, the “obscured” portions of the midground and background images may be dynamically shifted and/or reduced in brightness by an image processor depending on the viewing angle so that the obscured portions are realistically depicted as the viewing angle is changed.

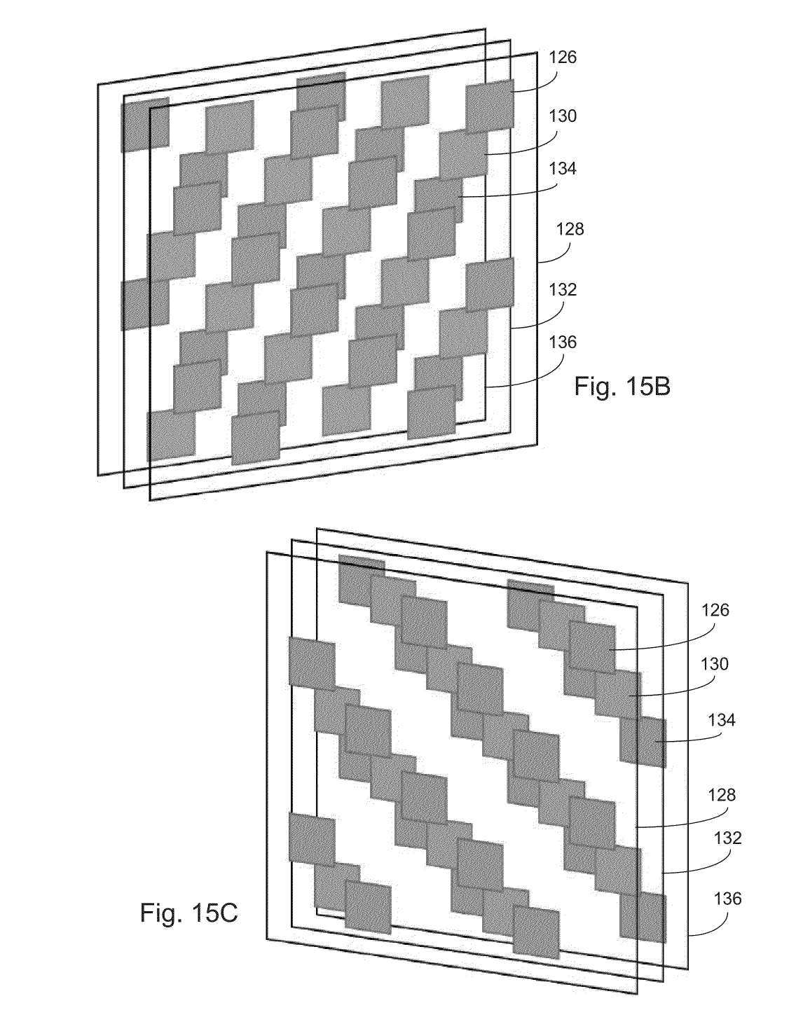

The 3-D images represented by FIGS. 15A, 15B, and 15C are simply three layers (depths) of 2-D arrays of squares. The squares displayed (by energized LEDs) on the foreground, midground, and background pixel layers do not overlap when viewed normal to the display surface. Therefore, the squares 126 in the foreground pixel layer 128, the squares 130 in the midground pixel layer 132 (FIGS. 15B and 15C), and the squares 134 in the background pixel layer 136 are all completely visible when viewed normal to the display surface. Each pixel layer displays 12 squares that are offset from the squares in the other pixel layers. The energized LEDs in a foreground image (displaying squares) obscure squares behind the energized LEDs at the particular viewing angle.

FIG. 15A depicts the image as viewed normal to the display surface, with each of the squares 126, 130, and 134 being visible and not obscured.

FIG. 15B illustrates what the viewer would see if the display were tilted to the right, with portions of the squares 130 and 134 in the midground and background being obscured, and the different depths of the 2-D arrays of squares being perceived. Optionally, the image processor can detect the relative angle of the display and control the images so that there is minimum interference between the overlapping images. The images may be assigned transparency factors that determine the percentage of backlight that can be perceived through images in the foreground. The brightnesses of the midground and background images may then be controlled (from zero to maximum) to reflect the effect on the image being obscured by a foreground image.

FIG. 15C illustrates what the viewer would see if the display were tilted to the left, with portions of the squares 130 and 134 in the midground and background being obscured, and the different depths of the 2-D arrays of squares being perceived.

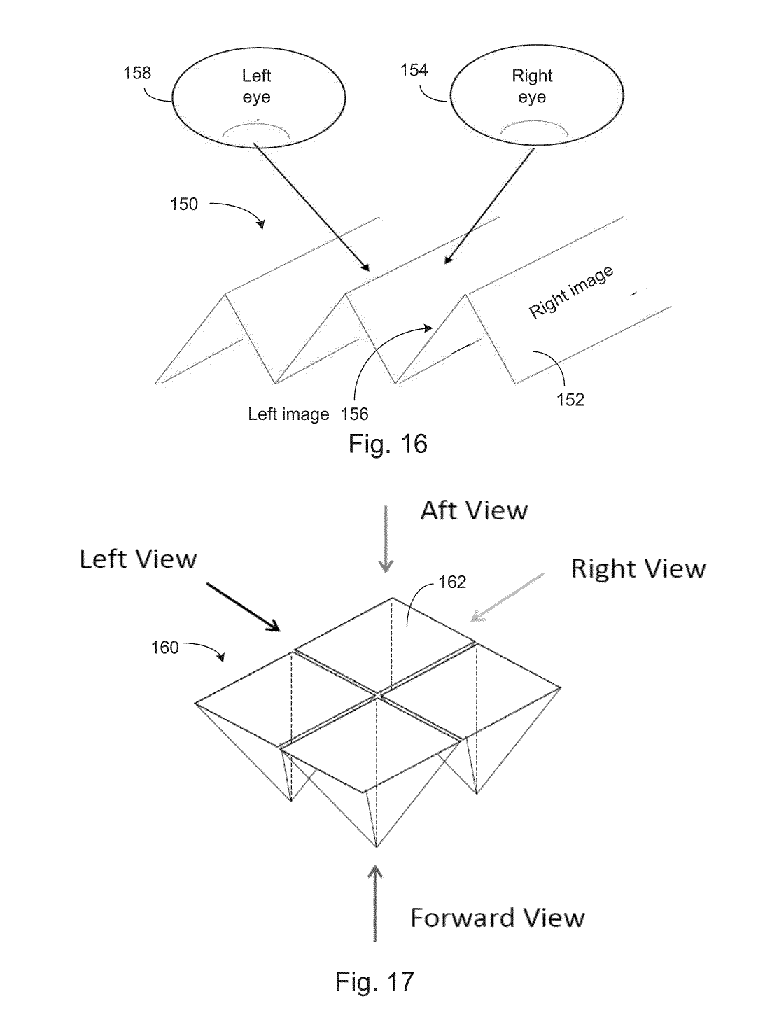

Instead of stacking layers of the transparent LED pixel sheets to form a 3-D display, one or more LED sheets can be folded to produce a 3-D stereoscopic image, as depicted in FIG. 16.

It is known to provide a flat image formed of interdigitated vertical segments of left eye and right eye images and then direct the left eye image to the viewer's left eye and direct the right eye image to the viewer's right eye. This has been traditionally done with lenticular lenses or opaque barriers. The technique is sometimes referred to as autostereoscopy. Other techniques use two separated images, and the viewer views the images through a stereoscopic lens system.

FIG. 16 depicts an alternative approach for conveying a 3-D image using a single sheet. This can only be achieved by a foldable display screen, such as the LED sheets described herein. The foldable LED sheet may be monochromatic, or may have red, green, and blue pixels, or may be three laminated LED sheets where each sheet has either red, green, or blue pixels. The different color pixels should be offset from one another.

The LED sheet 150 shown FIG. 16 is folded like an accordion so that one-half of the angled segments 152 face the viewer's right eye 154 and the other half of the segments 156 face the viewer's left eye 158. A right eye image is displayed on the segments 152 and a left eye image is displayed on the segments 156 to form the 3-D image. The angle of the folds is optimized for a particular viewing distance. The folds may be obtained by molding the LED sheet 150 using heat and pressure.

Although the folded LED sheet 150 presents 3-D image by its physical shape, the 3-D image can be further displayed by detecting the particular angle of the display with respect to the viewer and using an image processor to change the image accordingly to create a realistic 3-D image. This allows the displayed image to be dynamically changed as the viewer tilts the display left, right, up, or down. Accelerometers or a camera in the display may be used to detect the angle of the display.

A support member may be used to retain the folds, such as a semi-rigid material deposited on the back of the LED sheet 150 after it is folded. The image may be a dynamic scene or be static. The segments 152/156 can be any width and height.

FIG. 17 illustrates an LED sheet 160 that is molded to provide different views of an image when the display is tilted left, right, forward, and aft with respect to the viewer. In the example, the display is divided into pyramidal cells 162, where four different images are displayed on the four triangular segments in each cell. The pyramids do not have to have a square base. An image processor is programmed to display on each segment in each cell the appropriate image such that a 3-D image is perceived as the display is tilted left, right, forward, or aft with respect to the viewer. The display may even be rotated around 360 degrees while the image on each segment is dynamically changed to display a 3-D image. This effect achieved by the display of FIG. 17 may be referred to as a multi-scopic display.

Other shapes of the cells 162 may be used instead of pyramids, such as rectangles, hexagons, etc.

In another embodiment, rather than the cells 162 being concave portions of the LED sheet 160, the cells are convex to form positive pyramid shapes or other suitable shapes.

In any of the embodiments, multiple transparent LED sheets, each emitting a different primary color, may be laminated together to effectively form a single full-color LED sheet.

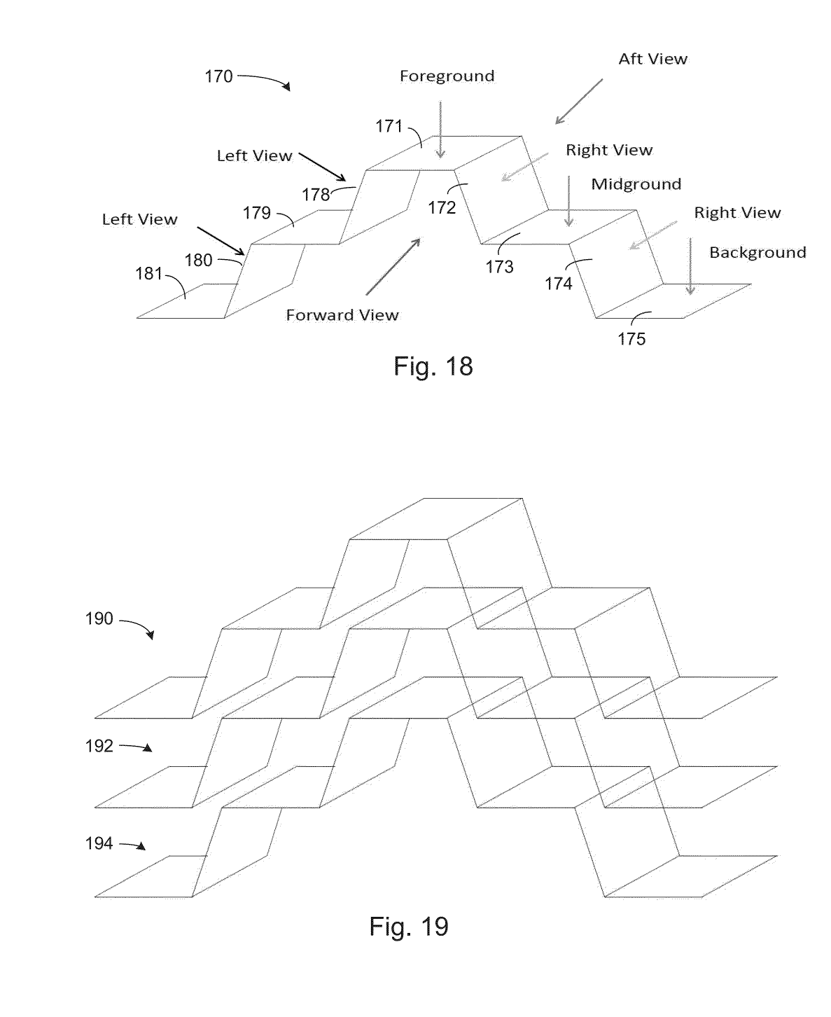

FIG. 18 illustrates a folded cascaded multi-scopic display. A narrow horizontal portion of a folded (molded) LED sheet 170 is shown. The LED sheet 170 may be a single layer or laminated layers to display desired colors. The portions of the LED sheet 170 that are facing to the right are primarily viewable by the viewer's right eye, and the portions of the LED sheet 170 that are facing to the left are primarily viewable by the viewer's left eye. The display is configured for a particular viewing distance. Different images are displayed by the two portions to create a stereoscopic 3-D effect. The segments 171-175, for the right eye, have different depths due to the physical depth of the LED sheet 170. So, in addition to the stereoscopic effect, the image has a physical depth, adding to the realism. An image processor may process the image to give the illusion of greater depth, as described with respect to FIGS. 12 and 13. Similarly, the segments 171 and 178-181 for the left eye are controlled in conjunction with the remaining segments to achieve the desired 3-D effect. Both eyes view the center foreground segment 171 equally. Any number of depth levels may be used, and the display can be any size. Each depth level may only be one or a few pixels wide.

In another embodiment, the flat sections 171, 173, 175, 179, and 181 are not active (e.g., transparent or opaque) so only the angled segments contribute to the displayed image.

FIG. 19 illustrates multiple spaced LED sheets 190, 192, and 194 that are cascaded for adding more physical depth to the 3-D display. Areas of an LED sheet that are not energized are transparent. Each LED sheet may display a different image for the foreground, midground, and background, as discussed with respect to FIGS. 11, 14, and 15, but each image also has its own 3-D effect by being displayed on a folded LED sheet. So, effectively, the 3-D display techniques of FIGS. 11, 14, 15, 16, and 18 are combined in FIG. 19.

In one embodiment, the folded LED sheet(s) can be stretched so as to change the angles of the folds to be optimized for any viewing distance.

Accordingly, various 3-D display techniques have been described that do not need any special lenses or glasses to achieve the 3-D effect. Such displays may be used for games, various effects, displaying CAD images for conceptualizing designs, advertising, or any other purpose. The display can be any size. For large size displays, the angles of the folds may be varied to account for the left and right eye viewing angles and viewing distance. Any aspects of the various embodiments may be combined.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A display device for displaying three-dimensional images comprising:
a plurality of stacked pixel layers, each pixel layer comprising a substantially transparent layer containing addressable light emitting diodes (LEDs) grouped into pixels; and
a controller for supplying currents to selected pixels in the stacked pixel layers such that energized pixels in the different pixel layers are simultaneously viewable through a viewing window of the display device to create a three-dimensional image.

2. The device of claim 1 wherein the LEDs in each pixel layer are microscopic and printed as an LED ink over a first transparent conductor layer in each pixel layer.

3. The device of claim 2 wherein the LEDs in each pixel are electrically connected in parallel by the first transparent conductor layer and a second transparent conductor layer sandwiching the LEDs in each pixel.

4. The device of claim 3 wherein each pixel contains a random number of LEDs as a result of printing the LEDs using the LED ink.

5. The device of claim 3 wherein the pixels in each pixel layer form a 2-dimensional matrix of pixels.

6. The device of claim 1 wherein the pixels include red, green, and blue pixels.

7. The device of claim 1 wherein the pixel layers have surfaces with a first index of refraction, the device further comprising spacer layers between the pixel layers that have surfaces with a second index of refraction substantially equal to the first index of refraction to reduce reflections.

8. The device of claim 1 wherein the pixel layers comprise first pixel layers that emit blue light, second pixel layers that emit green light, and third pixel layers that emit red light.

9. The device of claim 1 wherein each pixel layer comprises first pixels that emit blue light, second pixels that emit green light, and third pixels that emit red light.

10. The device of claim 1 wherein the pixels include red, green, and blue pixels, wherein the green pixels employ a first wavelength converting material that converts blue LED light to green light, and wherein the red pixels employ a second wavelength converting material that converts blue LED light to red light.

11. The device of claim 1 further comprising opaque walls around each pixel to reduce lateral cross-talk between pixels.

12. The device of claim 1 wherein pixels in adjacent pixel layers are offset from one another.

13. The device of claim 1 wherein the controller blocks pixels from being energized that are behind one or more energized pixels.

14. The device of claim 1 wherein the controller energizes the pixels to create a dynamically changing image.

15. The device of claim 1 wherein the controller energizes the pixels to create a static image.

16. The device of claim 1 wherein the controller comprises a permanent interconnection between selected pixels and a power source to display a fixed image.

17. The device of claim 1 further comprising row and column address lines electrically coupled to the pixels to activate selected pixels.

18. The device of claim 1 wherein the stacked pixel layers form a rectangular prism.

19. The device of claim 1 wherein the stacked pixel layers form a cube.

20. A display device comprising:
a first pixel layer comprising light emitting diodes (LEDs) grouped into addressable pixels, the first pixel layer being folded to create a plurality of first angled segments and a plurality of second angled segments, where the first angled segments are primarily viewable by a viewer's left eye, and where the second angled segments are primarily viewable by a viewer's right eye, wherein LEDs in the first angled segments and the second angled segments are energized to achieve a 3-D stereoscopic effect when viewed by the viewer's left and right eyes simultaneously.

21. The device of claim 20 wherein the first pixel layer is molded to be folded.

22. The device of claim 20 wherein there are multiple LEDs in each pixel,
wherein the LEDs are microscopic and printed as an LED ink, and
wherein the LEDs in each pixel are electrically connected in parallel by sandwiching the LEDs in each pixel between two conductor layers.

23. The device of claim 22 wherein each pixel contains a random number of LEDs as a result of printing the LEDs using the LED ink.

24. The device of claim 20 wherein the pixels in the first pixel layer form a 2-dimensional matrix of pixels.

25. The device of claim 20 wherein the first angled segments have a plurality of different depths, and wherein the second angled segments have a plurality of different depths such that depth of a displayed image is conveyed by both the 3-D stereoscopic effect and a plurality of physical depths of the first angled segments and the second angled segments.

26. The device of claim 25 wherein the first pixel layer is transparent, the device further comprising at least a transparent second pixel layer underlying the first pixel layer, and a third pixel layer underlying the second pixel layer, the second pixel layer and the third pixel layer having associated angled segments vertically aligned with the first angled segments and the second angled segments to add physical depth to a displayed image.

27. The device of claim 20 wherein the plurality of first angled segments and the plurality of second angled segments form angled walls of cells in the pixel layer.

28. The device of claim 27 wherein the cells are concave.

29. The device of claim 27 wherein the cells are convex.
